(19) United States
(12) Patent Application Publication
(10) Pub. No.: US 2017/0138343 A1
(43) Pub. Date: May 18, 2017

(54) Wind Turbine

(71) Applicant: Chien-Jung Tseng, New Taipei City (TW)

(72) Inventor: Chien-Jung Tseng, New Taipei City (TW)

(21) Appl. No.: 15/345,628

(22) Filed: Nov. 8, 2016

(30) Foreign Application Priority Data
Nov. 12, 2015 (TW) 104137281
Jul. 12, 2016 (TW) 105121958

(51) Int. Cl. F03D 3/04; F03D 3/00

(52) U.S. Cl. CPC F03D 3/0472; F03D 3/005; F05B 2240/217; F05B 2240/14; F05B 2240/12

(57) ABSTRACT

A wind turbine including a body, a blade set, a guiding module, a door set, and a fluid recovering element is provided. The body has a fluid inlet and a fluid outlet, wherein the fluid inlet includes a guiding area and a first opening area. The fluid outlet also includes a fluid recovering area and a second opening area. The blade set is pivoted in the body along a pivoting direction. The guiding module is disposed in the guiding area, and the door set is moveably disposed in the fluid inlet. The fluid recovering element is disposed in the fluid recovering area. The fluid recovering element covers a portion of the fluid outlet for guiding the working fluid to pass through the blade set and flow back into the body.

### BACKGROUND OF THE INVENTION

1. Field of the Invention

The present invention is related to a wind turbine, and more particularly, the present invention relates to a wind turbine with high efficiency.

2. Description of the Related Art

Currently, all types of wind turbines obtain kinetic energy from wind. In a wind turbine, wind passes through the blades of the wind turbine briefly, so the force of the wind cannot be captured entirely, resulting in low rotating efficiency of the blades. However, when the amount of blades is increased, the interval between any two blades is too small. The resulting turbulence when the interval is too small causes interference and reduces the rotating efficiency. In the design of a wide-type turbine with a larger wind contact area, when the amount of blades is greater than 3, the rotating resistance of the blades will increase and the wind turbine cannot be driven by the blades.

From the above description, it is clear that the turbines of the prior art still cannot provide high working efficiency, and there is a need for improvement.

### SUMMARY OF THE INVENTION

The main object of the present invention is to provide a wind turbine with high efficiency.

To achieve the abovementioned and other objects of the present invention, the present invention provides a wind turbine which is driven by a working fluid, the wind turbine comprising: a body, a blade set, a guiding module, a door set, and a fluid recovering element, wherein the body has a wall, and the wall has a fluid inlet and a fluid outlet. The fluid inlet has a guiding area and a first opening area, and the fluid outlet has a fluid recovering area and a second opening area.

In addition, the blade set is pivoted inside the body along a pivoting direction. The guiding module is disposed in the guiding area, and the door set is moveably disposed in the fluid inlet. The fluid recovering element is disposed in the fluid recovering area and connected to the wall such that the fluid recovering element covers a portion of the fluid outlet. The portion of the working fluid which flows into the body from the guiding area or the first opening area for driving the blade set to rotate is guided by the fluid recovering element to reflow into the body and drive the blade set to rotate, and the portion of the working fluid which flows into the body from the guiding area or the first opening area for driving the blade set to rotate flows out of the body through the second opening area.

In one embodiment of the present invention, the door set has a first door and a second door; the first door is connected to the wall and operated between a guiding position and a first closed position, and the second door is disposed in the wall and operated between a first open position and a second closed position, wherein when the first door is in the guiding position, the working fluid is guided to the guiding area through the first door and flows into the body for driving the blade set to rotate, and when the first door is in the first closed position, the first door covers the guiding module, and wherein when the second door is in the open position, the first opening area is opened through the operation of the second door, and the working fluid flows into the body for driving the blade set to rotate through the first opening area directly, and when the second door is in the second closed position, the second door covers the first opening area.

In one embodiment of the present invention, the wind turbine further comprises two swash plates respectively connected to two ends of the blade set along the pivoting direction and actuated with the blade set.

In one embodiment of the present invention, the wind turbine further comprises two sealing covers respectively covering two ends of the body along the pivoting direction.

In one embodiment of the present invention, the sealing covers are embedded at two ends of the body for making the sealing cover and the body be closed completely.

In one embodiment of the present invention, the wind turbine further comprises two supporting elements disposed inside the wall and respectively located on two opposite sides of the blade set, wherein the supporting elements are respectively fixed to the sealing covers.

In one embodiment of the present invention, the distance between each supporting element and the axis of the blade set is essentially equal to the rotating diameter of the blade set.

In one embodiment of the present invention, the fluid recovering element is a curved plate; one end of the curved plate is connected to the wall and extends to the other end curvedly.

In one embodiment of the present invention, the distance between at least one of the two ends of the fluid recovering element and the axis of the blade set is essentially equal to the rotating diameter of the blade set.

In one embodiment of the present invention, the blade set has multiple blades; each blade has a convex surface and a concave surface opposite to the convex surface, and the guiding module has multiple guiding plates disposed in the guiding area along the pivoting direction for guiding the working fluid to the concave surface of each blade.

In one embodiment of the present invention, the first door is pivoted to the wall along the pivoting direction and rotates between the guiding position and the first closed position.

In one embodiment of the present invention, the second door slides within the wall and reciprocates between the open position and the second closed position.

In one embodiment of the present invention, the body is a cylindrical body.

In one embodiment of the present invention, the pivoting direction is parallel to the axis direction of the cylindrical body.

In one embodiment of the present invention, the allocation range of the fluid recovering area in the periphery of the cylindrical body is 10°-50°.

In one embodiment of the present invention, allocation range of the fluid inlet and the fluid outlet in the periphery of the cylindrical body are 120° respectively.

In the wind turbine of the present invention, the design of the fluid recovering element can guide the working fluid which flows into the body from the guiding area or the first opening area for driving the blade set to rotate to reflow into the body for driving the blade set to rotate again, and thus the work efficiency of the wind turbine can be improved significantly.

### BRIEF DESCRIPTION OF THE DRAWINGS

These and other objects and advantages of the present invention will become apparent from the following descriptions of the accompanying drawings, which disclose several embodiments of the present application. It is to be understood that the drawings are to be used for purposes of illustration only, and not as a definition of the invention.

In the drawings, wherein similar reference numerals denote similar elements throughout the several views:

FIG. 1 is a schematic view illustrating the wind turbine according to one embodiment of the present invention.

FIG. 2 is a partial and exploded view illustrating the wind turbine depicted in FIG. 1.

FIG. 3 is an exploded view illustrating the wind turbine depicted in FIG. 1.

FIG. 4 is a schematic view illustrating the wind turbine depicted in FIG. 2 in the actuated state.

### DETAILED DESCRIPTION OF THE PREFERRED EMBODIMENT

To enable persons skilled in the art to understand the technical details of the present invention, the present invention is herein described with preferred embodiments and accompanying drawings.

In the present invention, the wide-type turbine is improved in a new innovative model. The present invention can significantly improve the work efficiency of the turbine and overcome the defects of the wide-type turbine of the prior art.

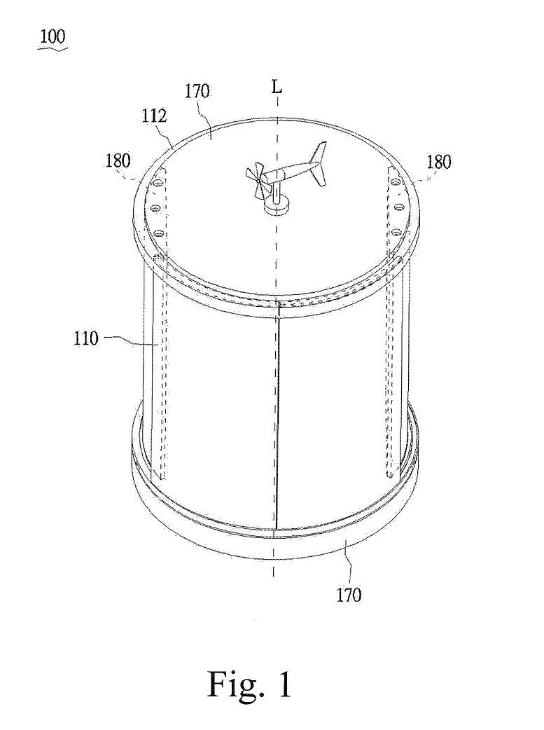

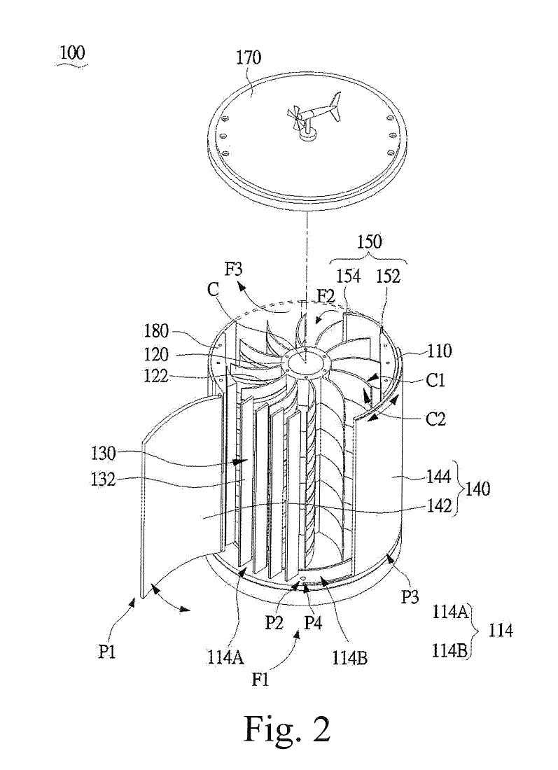

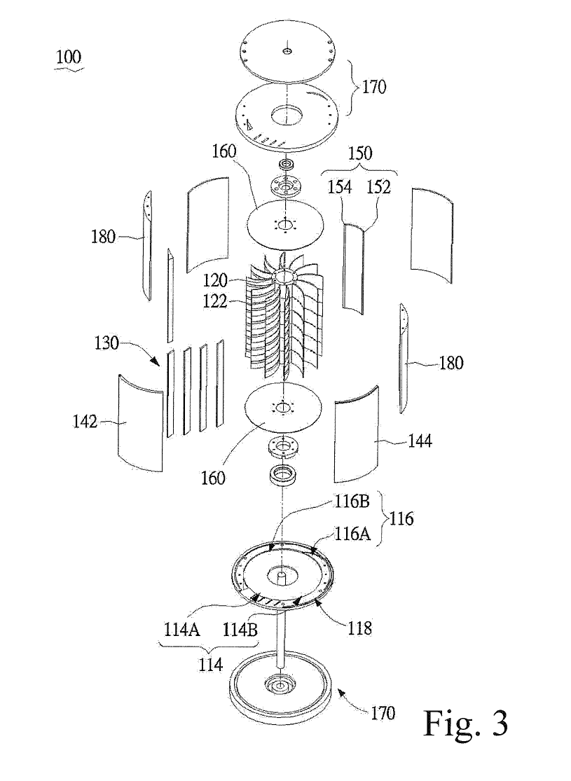

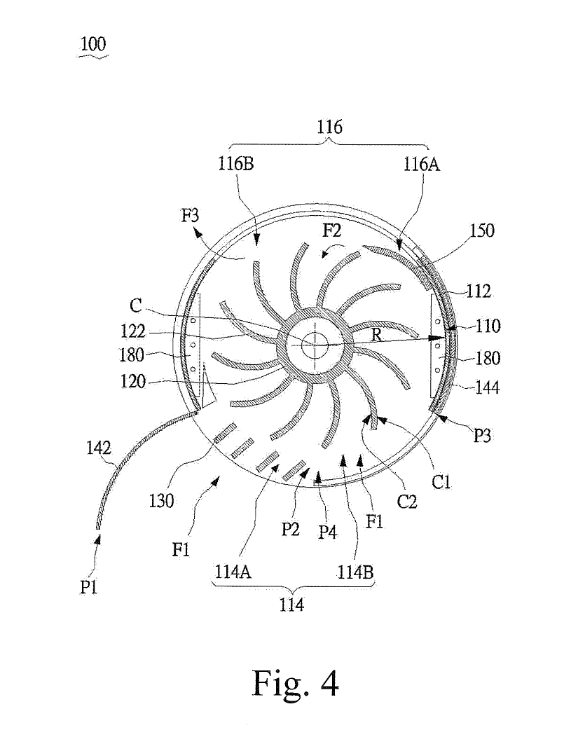

FIG. 1 is a schematic view illustrating the wind turbine according to one embodiment of the present invention. FIG. 2 is a partial and exploded view illustrating the wind turbine depicted in FIG. 1. FIG. 3 is an exploded view illustrating the wind turbine depicted in FIG. 1. FIG. 4 is a schematic view illustrating the wind turbine depicted in FIG. 2 in the actuated state.

Please refer to FIG. 1, FIG. 2, FIG. 3, and FIG. 4 regarding the wind turbine of the present invention. The present invention provides a wind turbine 100 which is driven by a working fluid F1 to generate kinetic energy. In the present embodiment, the wind turbine 100 comprises a body 110, a blade set 120, a guiding module 130, a door set 140, and a fluid recovering element 150. The body 110 is a cylindrical body. The blade set 120 is pivoted inside the body 110 along a pivoting direction L, and the pivoting direction L is parallel to the axis direction of the cylindrical body.

In addition, in the present embodiment, two swash plates 160 can be disposed at two ends of the blade set 120 respectively along the pivoting direction L. For example, the swash plates 160 can actuate with the blade set 120. Furthermore, the disposition of the swash plates 160 in the present embodiment is used to prevent loss of the working fluid passing through the two sides of the blade set 120. The working fluid can be, for example, wind. In other words, the flow can be restricted to the rotating range of the turbine blades by the design of the swash plates 160. Therefore, the kinetic energy and force of the flow can be captured entirely. Furthermore, the linkage between the swash plates 160 and the blade set 120 can make the swash plates 160 and the blade set 120 integrated as a whole for actuation. Therefore, the airflow can flow in the interior of the above-mentioned entirety and prevent the interference of the external environment.

In the present embodiment, the body 110 has a wall 112, and the wall 112 has a fluid inlet 114 and a fluid outlet 116. The fluid inlet 114 has a guiding area 114A and a first opening area 114B. The fluid outlet 116 has a fluid recovering area 116A and a second opening area 116B. The guiding module 130 is disposed in the guiding area 114A, and the door set 140 is moveably disposed in the fluid inlet 114.

In the wind turbine 100 of the present embodiment, the blade set 120 has multiple blades 122. Each blade 122 has a convex surface C1 and a concave surface C2 opposite to the convex surface C1. The guiding module 130 is constituted by multiple guiding plates 132. The guiding plates 132 are disposed in the guiding area 114A along the pivoting direction L. In order that the blade set 120 can be driven by application of the working fluid (airflow) effectively, in the present embodiment, a portion of the working fluid F1 can be driven to the concave surface C2 of each blade 122 by the disposition of the guiding plates 132 located in the guiding area 114A. The above-mentioned design of the guiding plates 132 can prevent a portion of the airflow from flowing toward the direction of the convex surface C1, which causes rotating resistance to the blade set 120. In other words, the design of the guiding plates 132 can guide the portion of airflow to flow toward the direction of the concave surface C2 and eliminate the possible rotating resistance. By the guidance of the guiding plates 132, the driving force of the blade set 120 can be increased.

Furthermore, in the present embodiment, the working fluid F1 is guided to contact the concave surface C2 of the blade 122 by the guiding plate 132 to generate thrust for driving the blade set 120. A portion of the working fluid F1 also can flow to the first opening area 114B directly and then flow to the concave surface C2 for driving the blade set 120 without guidance. In other words, by the design of the guiding plate 132 in the present embodiment, the working fluid F1 flowing into the fluid inlet 114 can cause the concave surface C2 of the blade 122 to receive a driving force to prevent the possible resistance described in the above-mentioned description. Therefore, the blade set 120 can be driven more effectively to generate greater efficacy.

In the present embodiment, the fluid recovering element 150 can be applied to increase the work efficiency of the wind turbine 100. In detail, in the present embodiment, a fluid recovering element 150 is disposed in the fluid recovering area 116A. In the present embodiment, the fluid recovering element 150 is connected to the wall 112 and covers a portion of the fluid outlet 116. Therefore, a portion of the working fluid F1 which flows into the body 110 from the guiding area 114A and the first opening area 114B for driving the blade set 120 to rotate will be guided by the fluid recovering element 150 to reflow into the body 110 and drive the blade set 120 to rotate repeatedly. Because the disposition of the fluid recovering element 150 can increase the work efficiency of the wind turbine 100 significantly, the wind turbine 100 of the present embodiment can be applied to power generation and power storage processes to increase the value of the energy industry.

In the present embodiment, the working fluid F2 that flows out of the body through the fluid outlet 116 originally will be guided to reflow into the body 110 to generate kinetic energy again for driving the blade set 120 repeatedly. The portion of the working fluid F3 which flows into the body 110 from the guiding area 114A and the first opening area 114B for driving the blade set 120 to rotate will flow out of the body 110 through the second opening area 116B.

In the present embodiment, the fluid recovering element 150 is, for example, a curved plate. One end 152 of the fluid recovering element 150 is connected to the wall 112 and extends to the other end 154 curvedly. Furthermore, in order that the fluid recovering element 150 will have preferred guiding effects, in the present embodiment, the distance between at least one of the two ends 152/154 of the fluid recovering element 150 and the axis C of the blade set 120 is essentially equal to the rotating diameter R of the blade set 120. Therefore, the flow of the working fluid which passes through the blade set 120 can directly be guided and returned into the body 110 again without any loss.

In order to control the flow which passes through the fluid inlet 114, the door set 140 of the present embodiment is composed of a first door 142 and a second door 144. The first door 142 is connected to the wall 112 and operates between a guiding position P1 and a first closed position P2, wherein the first door 142 of the present embodiment is a pushing door. The first door 142 is pivotally connected to the body 110 along the direction parallel to the pivoting direction L such that it can open and close. The first door 142 can be opened to a suitable location for guiding the working fluid F1. In the present embodiment, the first door 142 is a curved door, but the present invention is not thus limited.

Furthermore, when the first door 142 is in the guiding position P1, the working fluid F1 is guided to the guiding area 114A through the first door 142 and flows into the body 110 for driving the blade set 120 to rotate. When the first door 142 is located in the first closed position P2, the first door 142 covers the guiding module 130.

The second door 144 is similarly disposed in the wall 112 and operates between an open position P3 and a second closed position P4. In the present embodiment, the second door 144 of the present embodiment is a sliding door. The second door 144 can move between an open position P3 and a second closed position P4 along a track 118 disposed in the periphery of the body 110. Furthermore, when the second door 144 is in the open position P3 (as shown in FIG. 4), the first opening area 114B is opened entirely by the operation of the second door 144 such that the working fluid F1 can flow into the body 110 through the first opening area 114B directly for driving the blade set 120 to rotate. In addition, when the second door 144 is in the second closed position P4, the second door 144 covers the first opening area 114B. The second door 144 of the present embodiment can also be operated to a suitable location to cause the working fluid F1 to drive the blade set 120 more effectively and directly. The present embodiment does not have any limitation of the disposition of the second door 144 in a working state.

In the present embodiment, the wind turbine 100 further comprises two sealing covers 170. The two sealing covers 170 are embedded at two ends of the body 110. The sealing covers 170 are applied to cover two ends of the body 110 along the pivoting direction L respectively for closing the body 110 completely. Thus, the airflow can flow within the body 110 to reduce the interference of the external airflow effectively. In addition, in the present embodiment, two supporting elements 180 can be disposed in the inner of the wall 112 to cause the wind turbine 100 to have a preferred rigidity and a disposing strength when the wind turbine 100 is disposed in a severe environment. The distance between each supporting element 180 and the axis C of the blade set 120 is essentially equal to the rotating diameter R of the blade set 120, wherein the two supporting elements 180 are respectively located on two opposite sides of the blade set 120, and the supporting elements 180 are fixed to the sealing covers 170 disposed at two ends of the body 110 respectively. Therefore, the wind turbine 100 of the present embodiment has preferred rigidity and can be disposed in a severe environment more suitably.

Furthermore, to enhance the operating efficiency of the wind turbine 100 effectively, the allocation range of the guiding area 114A and the first opening area 114B in the periphery of the body 110 (cylindrical body) can be 60° respectively in the state wherein the body 110 (cylindrical body) has 360° of peripheral allocation range. This is, the maximum allocation range of the fluid inlet 114 can be 120° for the entrance of the working fluid F1. Similarly, the maximum allocation range of the fluid outlet 116 also can be 120° for the output of the working fluid F3. Specifically, in the present embodiment, the allocation range of the fluid recovering area 116A in the periphery of the cylindrical body is 10°-50°, and the fluid recovering element 150 can be disposed in the above-mentioned allocation range. In other words, the allocation range of the second opening area 116B is about 70°-110° for the output of the working fluid F3. In one preferred embodiment, the allocation range of the fluid recovering area 116A can be 15°-30°, and the allocation range of the second opening area 116B can be about 90°-105° for the output of the working fluid F3.

The above-mentioned allocation range of the fluid recovering area 116A and the workpiece dimensions of the fluid recovering element 150 can be considered according to the disposing environment of the wind turbine 100 or the blade dimensions of the blade set 120, such that the present embodiment does not have any limitation of the allocation range. In other allocation ranges of the above-mentioned elements, the wall 112 and the supporting elements 180 can be provided to increase the structural strength of the wind turbine 100.

In summary, in the wind turbine of the present invention, the design of the fluid recovering element can guide the working fluid which flows into the body from the guiding area or the first opening area for driving the blade set to rotate effectively to reflow into the body for driving the blade set to rotate again, and thus the work efficiency of the wind turbine can be improved significantly. Based on the disposition of the fluid recovering element, which can significantly increase the work efficiency of the wind turbine, the wind turbine of the present invention can be applied to power generation and power storage processes for upgrading the value of the energy industry.

In addition, the design of the swash plate in the present invention is used for preventing loss of the working fluid passing through the two sides of the blade set to prevent the interference of the external environment such that the kinetic energy and force of the working fluid can be captured entirely. In addition, the design of the door set in the present invention is such that the door set can be operated to a suitable location to cause the working fluid to drive the blade set more effectively and directly. By this design, the related power generation process can be greatly augmented. Generally, in order to dispose the wind turbine in a severe environment stably, the wind turbine of the present invention applies, for example, cylindrical structure with less wind resistance. In addition, the corresponding door also can be disposed in the fluid inlet and can be closed in severe conditions to protect the internal elements of the wind turbine from damage, and the corresponding door can be opened in suitable working conditions. Furthermore, the design of the door in the present invention can increase the entry area of the wind (the working fluid) to increase the air volume, capture more kinetic energy, and thus make related power equipment keep working and have a preferred power efficacy.

Therefore, compared to the prior art, the disposition of the fluid recovering element, the swash plate, the guiding module, the sealing cover, and the supporting element can make the wind turbine of the present invention have a preferred work efficiency as described in the above disclosure.

Although the invention has been described with reference to the above embodiments, it will be apparent to one of ordinary skill in the art that modifications to the described embodiments may be made without departing from the spirit of the invention. Accordingly, the scope of the invention should be defined by the attached claims rather than by the above detailed descriptions.

What is claimed is:

1. A wind turbine, driven by a working fluid, comprising:
a body, having a wall with a fluid inlet and a fluid outlet, wherein the fluid inlet has a guiding area and a first opening area, and the fluid outlet has a fluid recovering area and a second opening area;
a blade set, pivoted inside of the body along a pivoting direction;
a guiding module, disposed in the guiding area;
a door set, moveably disposed in the fluid inlet; and
a fluid recovering element, disposed in the fluid recovering area and connected to the wall, wherein the fluid recovering element covers a portion of the fluid outlet;
wherein the portion of the working fluid which flows into the body from the guiding area or the first opening area for driving the blade set to rotate is guided by the fluid recovering element to reflow into the body and drive the blade set to rotate, and the portion of the working fluid which flows into the body from the guiding area or the first opening area for driving the blade set to rotate will flow out of the body through the second opening area.

2. The wind turbine as claimed in claim 1, wherein the door set has a first door and a second door, the first door being connected to the wall and operated between a guiding position and a first closed position, and the second door being disposed in the wall and operated between an open position and a second closed position;
wherein when the first door is in the guiding position, the working fluid is guided to the guiding area through the first door and flows into the body for driving the blade set to rotate, and when the first door is in the first closed position, the first door covers the guiding module;
wherein when the second door is in the open position, the first opening area is opened through the operation of the second door, and the working fluid flows into the body for driving the blade set to rotate through the first opening area directly, and when the second door is in the second closed position, the second door covers the first opening area.

3. The wind turbine as claimed in claim 1, further comprising two swash plates respectively connected to two ends of the blade set along the pivoting direction and actuated with the blade set.

4. The wind turbine as claimed in claim 1, further comprising two sealing covers respectively covering two ends of the body along the pivoting direction.

5. The wind turbine as claimed in claim 4, wherein the sealing covers are embedded at two ends of the body such that the sealing covers and the body are completely closed.

6. The wind turbine as claimed in claim 4, further comprising two supporting elements disposed inside the wall and located on two opposite sides of the blade set respectively, wherein the supporting elements are respectively fixed to the sealing covers.

7. The wind turbine as claimed in claim 6, wherein the distance between each supporting element and axis of the blade set is essentially equal to the rotating diameter of the blade set.

8. The wind turbine as claimed in claim 1, wherein the fluid recovering element is a curved plate, one end of the curved plate being connected to the wall and extending to the other end curvedly.

9. The wind turbine as claimed in claim 1, wherein the distance between at least one of the two ends of the fluid recovering element and axis of the blade set is essentially equal to the rotating diameter of the blade set.

10. The wind turbine as claimed in claim 1, wherein the blade set has multiple blades, each blade having a convex surface and a concave surface opposite to the convex surface, and the guiding module has multiple guiding plates disposed in the guiding area along the pivoting direction for guiding the working fluid to the concave surface of each blade.

11. The wind turbine as claimed in claim 2, wherein the first door is pivotally connected to the wall along the pivoting direction and rotates between the guiding position and the first closed position.

12. The wind turbine as claimed in claim 2, wherein the second door slides within the wall and reciprocates between the open position and the second closed position.

13. The wind turbine as claimed in claim 1, wherein the body is a cylindrical body.

14. The wind turbine as claimed in claim 13, wherein the pivoting direction is parallel to the axis direction of the cylindrical body.

15. The wind turbine as claimed in claim 13, wherein the allocation range of the fluid recovering area in the periphery of the cylindrical body is 10°-50°.

16. The wind turbine as claimed in claim 13, wherein the allocation ranges of the fluid inlet and the fluid outlet in the periphery of the cylindrical body are 120° respectively.
